(19) United States
(12) Patent Application Publication
(10) Pub. No.: US 2019/0106331 A1
(43) Pub. Date: Apr. 11, 2019

(54) GETTER MATERIAL COMPRISING INTRINSIC COMPOSITE NANOPARTICLES AND METHOD OF PRODUCTION THEREOF

(71) Applicant: DISRUPTIVE MATERIALS AB, Uppsala (SE)

(72) Inventors: Ocean CHEUNG, Stockholm (SE); Peng ZHANG, Uppsala (SE); Sara FRYKSTRAND ÅNGSTRÖM, Sollentuna (SE); Tommi REMONEN, Mariehamn (FI); Jiaojiao YANG, Uppsala (SE); Cecilia ÅRHAMMAR, Uppsala (SE)

(73) Assignee: DISRUPTIVE MATERIALS AB, Uppsala (SE)

(21) Appl. No.: 16/090,921

(22) PCT Filed: Mar. 31, 2017
(86) PCT No.: PCT/EP2017/057692

§ 371 Date: Oct. 3, 2018

(30) Foreign Application Priority Data
Apr. 4, 2016 (SE) 1650452-4

(51) Int. Cl. C01F 5/02; C01F 5/24

(52) U.S. Cl. CPC C01F 5/02; C01F 5/24; C01P 2002/02; C01P 2004/62; C01P 2004/64; B82Y 30/00; C01P 2006/60; C01P 2002/70; C01P 2002/84; C01P 2004/03; C01P 2006/14; C01P 2004/80

(57) ABSTRACT

The present invention relates to a getter material and a production method thereof. The method enables control of a sol-gel process so that a nanoparticle getter material with intrinsic nanoparticles in a size range from 10 nm to 1 μm can be produced with accurate size control. The intrinsic nanoparticles of the getter material are composites of magnesium oxide and amorphous magnesium carbonate, substances that have properties that are highly interesting for getter applications. The composition ratio of magnesium oxide to magnesium carbonate may preferably be in the range from 5:95 to 50:50.

### FIELD OF THE INVENTION

The present invention relates to moisture adsorption materials. In particular the invention relates to getter materials comprising magnesium carbonate and which is suitable for transparent encapsulation and/or inclusion in thin films.

### BACKGROUND OF THE INVENTION

Getters. or getter materials, is a class of materials used as adsorbents within a sealed enclosure. Typical devices wherein a getter is provided are electrical and electronic components, vacuum equipment and optical instruments. A further use is in packages and wrapping wherein an object is protected during storing or transportation. Getter materials may be designed to adsorb moisture, i.e. to act as a desiccant, or to react with specific elements, or a combination thereof.

Modern electronic devices, such as OLED displays, have put new demands on encapsulation solutions. One important part is getter material provided in the device and often in/on or close to an encapsulation layer. OLED displays, for example, are extremely sensitive to moisture, the surface area of the device is large and the getter material has to be provided on or in a part of the enclosure that is facing the viewer. Hence the getter material needs to be highly transparent in the visible wavelength region. One approach has been to provide the getter material as small particles, preferably with a size below 1 μm, even more preferably nanoparticles with a size in the order, or below the wavelength of visible light. Small particles of getter material is also advantageous in flexible displays, wherein the flexibility itself typically requires thin films. Getters of small particles also reduce internal wear in flexible constructions. A further reason why small particles are attractive is the current trend of producing by additive methods like ink-jet printing and slot die coating. In such production methods all solid constituents need to be well below sizes of the nozzle or the slit, typically a few micrometers.

Another area wherein transparency is of advantage is packaging, in particular food packaging. In food packaging getter materials are used both for moisture control and to reduce odour. Also here the size of the getter material particles need to be small as the food packaging films are usually multilayer structures made up of a plurality (3-10) thin layers, each layer typically 5-25 μm thin.

Zeolites are well known as getter materials and “Flexible and transparent moisture getter film containing zeolite”, Chien-ShengWu, Adsorption (2010) 16: 69-74, discloses nanoparticle zeolites intended to be provided in a transparent encapsulation of an OLED display. In production of zeolites different types of templates are used to achieve the nanostructured properties. Also in this study templates, for example Tetraethylammonium hydroxide (TEAOH), was utilised. Different measures are typically done to later in the processes remove the templates, but residual templates is a well-known problem with nanostructured zeolites. Emission of unwanted substances during use of the getter material is particularly problematic in the highly sensitive OLED as well as in other high resolution displays and sensors.

“Preparation of CaO as OLED getter material through control of crystal growth of CaCO₃ by block copolymers in aqueous solution”, Jac-Hyung Park, Materials Research Bulletin 44 (2009) 110-118, discloses production method of CaO nanoparticles intended as a constituent in getter materials. The method of production requires to synthesize CaO nanoparticles by thermal decomposition at 600° C. for 3 h under vacuum using CaCO₃ prepared by additives/templates. High temperature vacuum processes are generally regarded as unfavourable for large scale industrial production.

U.S. Pat. No. 9,580,330 discloses a template-free synthesis of an amorphous mesoporous magnesium carbonate material with average pore size around 5 nm in diameter. Further investigations disclosed the pore forming mechanism in further detail and it was suggested that the pores were created in a two-step process including the formation of micropores by solvent evaporation and release of physically bound carbon dioxide, followed by micropore-expansion to mesopores due to partial decomposition of organic groups on the surface of the pore walls when the material is stored in air at moderate temperatures. The amorphous mesoporous magnesium carbonate material is formed as a continuous material and typically provided in powder form with chunks of the material at a size in the order of micrometers (10 μm) and upwards. An amorphous magnesium carbonate material have properties that could be highly interesting in the above mentioned getter applications.

### SUMMARY OF THE INVENTION

Getter materials that do not give off residual substances, that can be provided in small enough particle sizes to be used in transparent layers and which are not too costly to produce in large scale, are highly sought for since the emergence of sensitive display devices, thin film applications and in sensor technology, for example. Recent reports suggest the use of zeolite nanoparticles and calcium oxide nanoparticles, but these materials or the production methods thereof, do not meet all of the stated requirements.

The object of the invention is to provide a getter material and a production method that overcomes the drawbacks of prior art techniques. This is achieved by getter material as defined in claim 1, the intrinsic composite nanoparticle as defined in claim 10 and the method as defined in claim 12. The method enables control of a sol-gel process so that a nanoparticle getter material with nanoparticles in a size range from 10 nm to 1 μm can be produced with accurate size control. The nanoparticles of the getter material are composites of magnesium oxide and amorphous magnesium carbonate, substances with properties that are highly interesting for getter applications.

The getter material according to the invention is suitable for incorporation in transparent layers, thin films or printed layers, and comprises intrinsic composite nanoparticles comprising one or more cores of crystalline magnesium oxide surrounded by amorphous magnesium carbonate. 90% of the intrinsic composite nanoparticles is in a size range from 10 nm to 1 μm. Preferably 90% of the intrinsic composite nanoparticles is in a size range from 10 nm to 200 nm, and even more preferably from 10 nm to 50 nm. The composition ratio of magnesium oxide to magnesium carbonate of the getter material, may preferably be in the range from 5:95 to 50:50, as determined by Energy Dispersive X-ray Spectroscopy

According to one aspect of the invention the transmittance, T, for a suspension of the intrinsic composite nanoparticles in the visible region of 400-800 run is, T>60% at a concentration of 600 mg/l, T>70% at 400 mg/l and T>80% at 200 mg/l.

According to a further aspect of the invention the getter material may further comprises additional particles comprising a metal oxide, preferably an alkaline earth metal oxide, such as MgO or CaO. Preferably these additional particles are nanoparticles. The additional particles may have been added during the production process, which can be done at a plurality of stages in the process. Alternatively, if MgO nanoparticles are to be present in the final product, at least a portion of the magnesium oxide particles may be residues from a process of producing the intrinsic composite nanoparticles. The “reuse” of residue MgO nanoparticles represents an advantage from a production perspective.

According to one aspect of the invention the getter material is provided in a liquid suspension. At least a portion of the liquid suspension may be the sol-gel suspension utilized in the production process. The liquid suspension may also comprise a solvent or mixture of solvents such as alcohols, ethers, hydrocarbons and ketones. It is an advantage of the present invention that it is easy to provide a particle suspension that is suitable for the intended usage.

According to one aspect of the invention an intrinsic composite nanoparticle is provided comprising one or more cores of magnesium oxide. The one or more cores surrounded by a shell of amorphous magnesium carbonate and together forms a composite nanoparticle. The size of the composite nanoparticles is in a size range from 10 nm to 50 nm. The composition ratio of magnesium oxide to magnesium carbonate within the intrinsic composite particle, is preferably in the range from 5:95 to 50:50, as determined by Energy Dispersive X-ray Spectroscopy.

The method according to the invention of producing a getter material comprising intrinsic composite nanoparticles comprising magnesium oxide and amorphous magnesium carbonate, comprises the main steps of:
sol-gel synthesis comprising mixing crystalline magnesium oxide and methanol under CO₂ pressure resulting in a sol-gel suspension;
formation of composite nanoparticles in the sol-gel suspension, the nanoparticles formed with at least one core of crystalline magnesium oxide surrounded by amorphous magnesium carbonate;
halting formation and growth of nanoparticles in the sol-gel suspension by addition of a solvent.

The solvent may be petroleum ether, ethanol, methanol or ethyl acetate or combinations thereof.

According to one aspect of the invention the method comprises a step of adding adding crystalline particles of a metal oxide or an alkaline earth metal oxide.

According to one aspect of the invention the getter material is provided dispersed in a plastic material, preferably a plastic film and preferably a thin plastic film. A non-limiting example of a plastic material which has been provided with the getter material according to the invention is polyethylene.

Thanks to the inventive getter material and method of production a getter material is provided that has physical dimensions that allows it to be incorporated in thin films, have physical dimensions that allows it to be ink-jettable or slot die coated and have optical properties suitable for transparent encapsulation. Thanks to the method not introducing any templates, surfactants or the like, for example complex organic molecules, the risk of having residues in the final product is greatly reduced. Alternatively a production step burning off residue can be avoided.

One advantage with the method and getter material according to the invention further relates to the possibility of providing a mixed material wherein the intrinsic composite nanoparticles in combination with another nano-material is produced to a nano-agglomerate, that alters/enhances the materials functions as a getter. This other nanomaterial can be the core oxide only, intentionally non-reacted MgO from the synthesis (i.e. not apply separation/centrifugation) or the addition of another nanomaterial (nano MgO, MgCO3, CaO) for the intrinsic composite nanoparticles to co-agglomerate with.

A further advantage is the ability to precisely tailor the particle size to a specific application.

A further advantage of the getter material according to the invention is that moisture is bound by different processes, for magnesium carbonate as crystal water and for magnesium oxide as a reaction to magnesium hydroxide. This gives the possibility to tailor the moisture uptake to a specific application.

### BRIEF DESCRIPTION OF THE FIGURES

A more complete understanding of the above mentioned and other features and advantages of the present invention will be apparent from the following detailed description of preferred embodiments in conjunction with the appended drawings, wherein:

FIG. 1 is a schematic illustration of the nanoparticle forming mechanism utilized in the method according to the invention and the internal pore forming mechanism utilized in other methods:

FIG. 2 is a flowchart illustrating the steps of a method forming a material with internal pores:

FIG. 3 is a is a flowchart illustrating the steps of a method according to the present invention.

FIGS. 4 a-b illustrates the getter material according to the invention comprising intrinsic composite nanoparticles, a) is a schematic illustration of the getter material, and b) is a SEM-image of a sample of the material according to the invention;

FIG. 5 a-b are SEM images of (a) getter material according to the present invention and (b) a continuous porous material with internal pores according to U.S. Pat. No. 9,580,330 (Prior Art);

FIGS. 6 a-c are graphs showing UV-VIS transmittance spectra of suspensions of a) the getter material according to the present invention prepared from dried power, b) a continuous porous material with internal pores material with internal pores according to U.S. Pat. No. 9,580,330 (Prior Art) prepared from dried powder, and c) three samples of the getter material according to the invention prepared from respective reaction fluid (sol-gel suspension);

FIG. 7 is a schematic illustration of a display wherein the getter material according to the invention is incorporated;

FIG. 8 is a graph showing the particle size of the particles in the reaction mixture after centrifugation and 24 hours of reaction detected by dynamic light scattering:

FIG. 9 is a SEM image of a getter material according to the invention comprising intrinsic composite nanoparticles mixed with CaO:

FIG. 10 is a SEM image and a graph showing stacked SEM-EDS line scans of a getter material according to the invention comprising intrinsic composite nanoparticles mixed with CaO;

FIG. 11 is a SEM image showing intrinsic composite nanoparticles embedded in polyethylene plastics.

### DETAILED DESCRIPTION OF THE INVENTION

The material according to the invention is a composite material that comprises nanometre-sized MgO parts surrounded by amorphous MgCO₃. By altering the production process the composite material may be provided as intrinsic composite nanoparticles or as a continuous porous material with internal pores. The intrinsic composite nanoparticle may comprise one or more cores of magnesium oxide surrounded by amorphous magnesium carbonate. The intrinsic composite nanoparticle may be formed of a number of clustered smaller composite nanoparticles. Hereinafter, the term intrinsic composite nanoparticle is used to refer to all these different nanoparticle structures which are in size range of 10 nm to 1 μm. The continuous composite porous material with internal pores, hereinafter referred to as continuous porous material, comprises internal mesopores of an average pore size in the range ˜2 nm to ˜30 nm. The method according to the invention also provides a way of controlling the average size of the intrinsic composite nanoparticles.

The term intrinsic is used herein to indicate that the particle receives it shape and size, the size range being 10 nm to 1 μm as a direct result of the chemical process producing the particle material. No further step, such as grinding or milling, is needed to achieve particles in the defined size range.

The term getter material is used to indicate that the produced material is particularly useful in applications typically associated with getter materials, such as adsorption of moisture or of gases/molecules. It is not intended as a limitation to such applications only. The material according to the invention may be used in a wide range of application, including but not limited to filler materials, filter materials, isolation materials and gas adsorption materials.

The continuous porous material and composite nanoparticles are synthesised using inventive new methods based on the sol-gel synthesis method disclosed in the above discussed reference, U.S. Pat. No. 9,580,330. The methods comprise the main steps of i) sol-gel synthesis resulting in a sol from which superfluous MgO particles could be removed by centrifugation, ii) powder formation typically involving stirring that activates gelling and subsequent wet powder generation and finally iii) degassing or drying. If intrinsic composite nanoparticles are to be produced, the second step ii) is altered iib) to controlling the gel formation and nanoparticle growth by halting the process before a complete agglomeration is achieved by the addition of solvent to the sol-gel suspension. Addition of solvent includes providing solvent to the sol-gel suspension and providing the sol-gel suspension to a solvent.

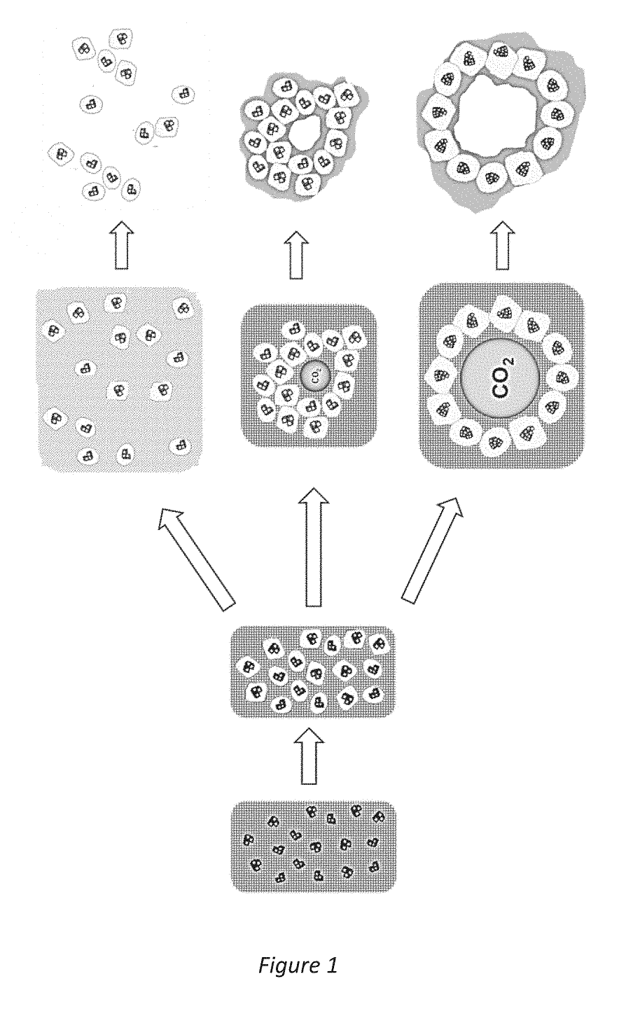

The process of forming intrinsic composite nanoparticles and continuous porous material, both in a sol-gel synthesis, is schematically illustrated in FIG. 1. In a first main stage i) the MgO particles used as precursor are dissolved/reacted in the solution to a point where essentially only nano-sized crystals of MgO remains. In a second stage ii) amorphous MgCO₃ is formed around crystals of MgO. In a third stage iii) the gel formation is controlled to either result in individual or clustered composite nanoparticles (upper path) or form a continuous composite porous material with internal mesopores (the two lower paths). The average size of the mesopores could be controlled from ˜3 nm to ˜20 nm by adjusting the gel/powder formation rate in the powder formation step by controlling the agglomeration of CO₂ molecules into bubbles. During this step, a large amount of CO₂ is given off. The eliminated gas phase CO₂ molecules need to travel to the liquid/air interface between the reaction mixture/gel and ambient air before evaporating from the reaction mixture into gas phase. However, when inside the reaction mixture, the CO₂ molecules aggregate to form bubbles. Nanometre-sized particles (MgCO₃/MgO composites) assemble around these CO₂ bubbles which are then essentially trapped in this configuration. The average size of the bubble renders the average pore size of the material. Low temperature allows CO₂ molecules to form aggregates in the reaction mixture at a higher extent than at high temperature (due to slower kinetics). The lower path in the FIG. 1 illustrated the formation process at lower temperatures and the middle path at higher temperatures. After the wet powder forms, the pores need to be fixed by heating under N₂ flow in a carefully controlled way in a degassing step. This step fixes the shape of the assembled powder particles and removes the trapped CO₂ bubbles, resulting in a porous solid.

The uppermost path in FIG. 1 illustrates that the gel formation can be controlled to result in intrinsic composite nanoparticles. The size of the nanoparticles and/or forming of clusters of nanoparticles can be controlled by addition of different solvents, temperature and stirring speed, for example.

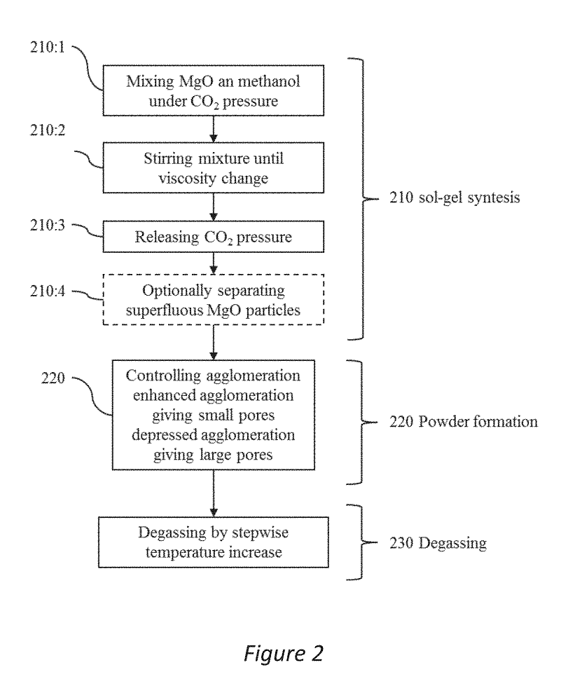

The method of producing continuous porous material will be described with references to the flowchart depicted in FIG. 2:

210. Sol-Gel Synthesis. Comprising the Steps of:

210.1: mixing magnesium oxide and methanol under CO₂ pressure. The CO₂ pressure should be above atmospheric pressure and preferably 1-5 bar.

210.2: stirring the mixture until a change in viscosity can be observed. As realized by the skilled person the mixture may be subjected to other types of mechanically work, such as shaking, tumbling and mixing. A typical process time for this step is in the order of 1 to 10 hours at room temperature.

210.3: realising CO₂ pressure obtaining a cloudy, yellowish solution or suspension.

210.4: optionally separating superfluous MgO particles for example by centrifuging at 5000 rpm (4696 g) for 60 minutes to obtain an optically clear, off-white coloured liquid and discarding solid particles. The skilled person may apply other separation methods.

220. Powder Formation:

220: controlling the agglomeration of CO₂ molecules in the above obtained suspension into bubbles in such a way that agglomeration is suppressed if the average size of the mesopores of the resulting continuous porous material magnesium carbonate should be small as compared to the achievable range of mesopores, and the agglomeration is enhanced if the average size of the mesopores should be large as compared to the achievable range of mesopores, the achievable range of mesopores being ˜2 nm-˜30 nm. The agglomeration of CO₂ molecules into bubbles is suppressed by any means that increases the evaporation rate of CO₂ from the mixture, for example increasing the temperature of the mixture or by subjecting the mixture to mechanical work such as, but not limited to, stirring, tumbling or shaking. The agglomeration of CO₂ molecules into bubbles is enhanced by any means that decreases the evaporation rate of CO₂ from the mixture, for example lowering the temperature of the mixture or by providing a mechanically undisturbed environment. The useful temperature range in this step is −20 to 80° C.

The suspension would first thicken into a gel (an alcogel) before breaking up into small, wet powder-like pieces, referred to as wet powder, which is used as an indication that the step is completed.

230. Degassing, Comprising the Steps of:

Degassing or drying the wet powder need to be done in a controlled manner to preserve the highly porous structure of the magnesium carbonate. For example, to directly heat at an elevated temperature, typically above 150° C., could destroy the porous structure and result in a nonporous magnesium carbonate. The degassing is preferably done stepwise, wherein the temperature is increased stepwise and at each temperature degassing is performed until a stable condition is achieved, with regards to the gas given off. The stable condition could be determined by monitoring the weight of the wet powder and not increase the temperature until the weight decrease diminish, observe the rate of the gas given off, or by testing out an appropriate drying scheme by analysing the resulting magnesium carbonate. Alternatively, a continuous increase of the degassing temperature could be utilized, given that the continuous increase is careful enough. Given the knowledge that the degassing needs to be carefully controlled in order to preserve the highly porous nature of the magnesium carbonate, the skilled person may design an appropriate degassing scheme. The degassing should be performed under a slow flow, typically at ˜20 cm³/minute, of a non-reactive gas, i.e. not reacting with the compounds in the wet powder. Nitrogen is a preferred choice of a non-reacting gas.

In the step of controlling agglomeration (120:1) subjecting the mixture to mechanical work can be done in various ways. In the process described below as a non-limiting example, stirring the suspension obtained in the sol-gel synthesis step is done at 60-100 rpm in a ventilated area. Appropriate speed and duration will depend on for example size and shape of the reactor vessel, the stirring gear etc. In similar way may the parameters need adjustments if other means of subjecting the suspension to mechanical work is used, for example shaking, tumbling, vibrating etc. The skilled persons will, with guidance from the method according to the invention and from the discussion presented below about the agglomeration and pore formation, be able to choose a suitable means for controlling the agglomeration to produce the desired average pore size.

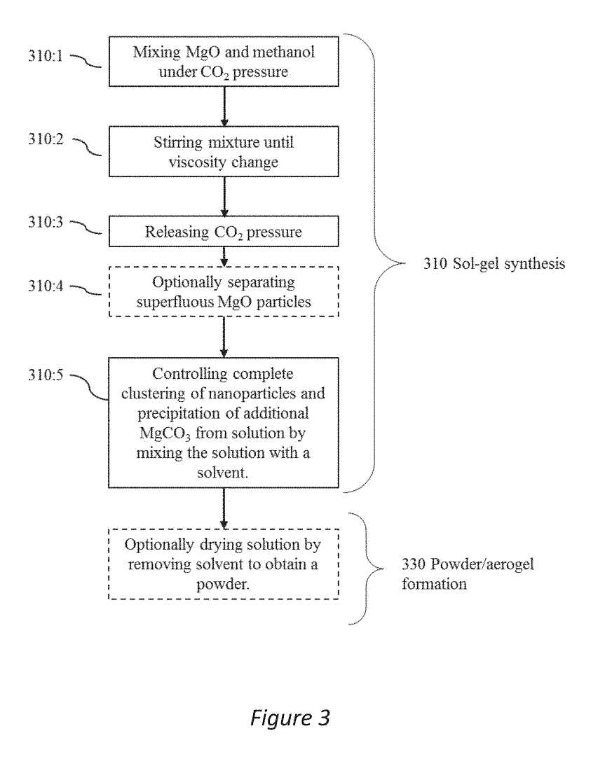

The method according the invention of producing intrinsic composite nanoparticles and a getter material comprising intrinsic composite nanoparticles of MgO and amorphous MgCO₃ will be described with references to the flowchart depicted in FIG. 3:

310. Sol-Gel Synthesis, Comprising the Steps of:

310.1: mixing magnesium oxide and methanol under CO₂ pressure. The CO₂ pressure should be above atmospheric pressure and preferably 1-5 bar.

310.2: stirring the mixture until a change in viscosity can be observed. As realized by the skilled person the mixture may be subjected to other types of mechanically work, such as shaking, tumbling and mixing. A typical process time for this step is in the order of 1 to 10 hours at room temperature.

310.3: realising CO₂ pressure obtaining a cloudy, yellowish solution or suspension, referred to as the sol-gel suspension.

310.4: optionally separating superfluous MgO particles for example by centrifuging at 5000 rpm (4696 g) for 60 minutes to obtain an optically clear, off-white coloured liquid and discarding solid particles. The skilled person may apply other separation methods. This step may also be carried out after addition of solvent (see powder formation).

310.5. The step comprises controlling agglomeration process to avoid complete agglomeration of nanoparticles and precipitation of additional MgCO₃, by mixing with a solvent. Nanoparticles are formed in the second step of the sol-gel synthesis described in 310, where MgCO₃ precipitates on the MgO nano-sized crystals obtained in the synthesis. By subjecting the sol-gel suspension formed in 310 to a solvent, agglomeration of the nanoparticles and precipitation of additional MgCO₃ from the solution is essentially halted so that further gel formation is avoided. This results in a suspension of intrinsic composite nanoparticles or clusters of nanoparticles, which upon drying gives a powder of nanoparticles, or an aerogel. The intrinsic composite nanoparticles are composed of magnesium oxide and amorphous magnesium carbonate, and the size of the nanoparticles or clusters can be controlled by the choice of method. The intrinsic composite nanoparticles may be formed by subjecting the suspension to various solvents for example, but not limited to petroleum ether (PE), ethanol (EtOH), methanol or ethyl acetate (EtAc) or combinations thereof. The solvent may be mixed with the sol-gel suspension by adding the solvent to the sol-gel suspension, or alternatively, the sol-gel suspension is added to the solvent. The skilled person appreciates that adding/mixing can be made with a plurality of techniques suitable for industrial processes, for example spraying the reaction suspension into the co-solvent.

The choice of solvent may be used to control the size of the formed nanoparticles. The size may also be controlled by other factors such as the addition rate of the solvent/suspension, temperature, the way the solvent is disparaged in the sol-gel suspension or stirring speed for example.

The step of separating superfluous MgO particles may also be carried out after the solvent addition.

330. Drying, Comprising the Steps of:

Drying the wet powder need to be done in a controlled manner to preserve the integrity of the formed magnesium oxide/magnesium carbonate particles. For example, to directly heat at an elevated temperature, typically above 150° C., could destroy the structure and result in a complete agglomeration of the particles. Given the knowledge that the drying needs to be carefully controlled in order to preserve the integrity of the formed particles of the magnesium carbonate, the skilled person may design an appropriate drying scheme, for example freeze drying, spray-drying, and solvent extraction.

A solvent exchange procedure may be utilized prior to the drying step 330 in order to facilitate an effective drying. A solvent exchange may for example be used to lower the volume of the liquid suspension and thereby smaller reaction chambers or drying chambers can be used.

As one skilled in the art can realize the drying may also be performed by different well-known methods such as spray-drying, solvent extraction or freeze-drying etc.

For certain application it may be advantageous to provide the getter material in a solvent (as a suspension). For this type of products the drying step is omitted or altered. The solvent in such a liquid product may be the sol-gel suspension used in the sol-gel synthesis step 310 or a mixture of the sol-gel suspension and the added solvent. Alternatively the solvent (or sol-gel suspension/solvent mixture) is replaced by another solvent by a solvent exchange method. A further alternative is to disperse the dried powder comprising the intrinsic composite nanoparticles in a solvent to provide the liquid product. A wide range of solvent could be utilized, including but not limited to Methanol (MeOH) Ethanol (EtOH), iso-Propanol (iso-P). Butanol (BuOH) or any other suitable alcohol, Petroleum Ether (PE) of various boiling point ranges, Diethyl Ether Diethyl ether, Diisopropyl ether, tert-butyl methyl ether (MTBE) or any other suitable ether, Dioxane, Toluene. Sulfolane, Ethyl acetate. Pentane. Hexane. Octane. Cyclohexane or any other suitable hydrocarbon solvent, Aceton, Metyletylketon (MEK) and Butanon or other suitable ketone. The selection preferably done to be suitable for the intended application, and the ability of the getter material to be combined with a large variety of solvents is an advantage as specific application may call for specific solvents.

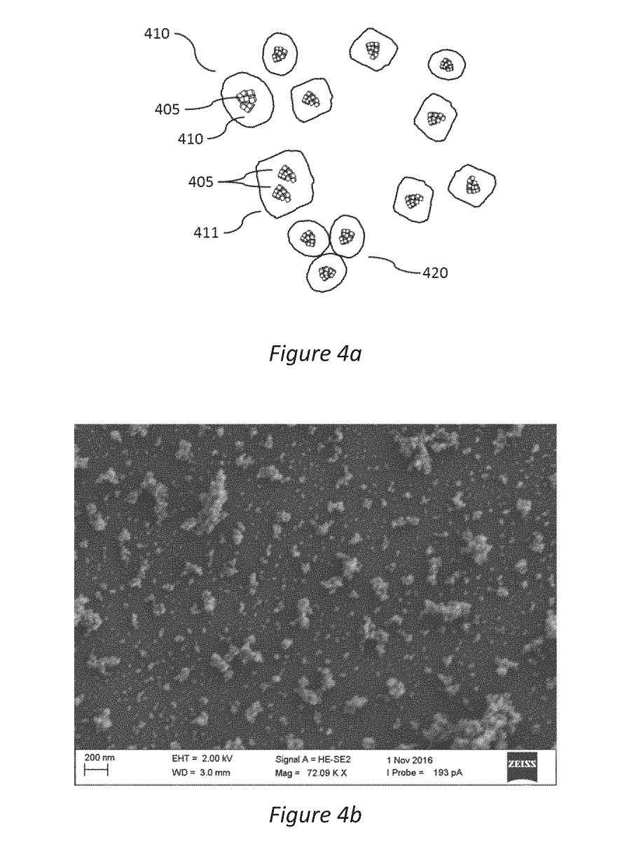

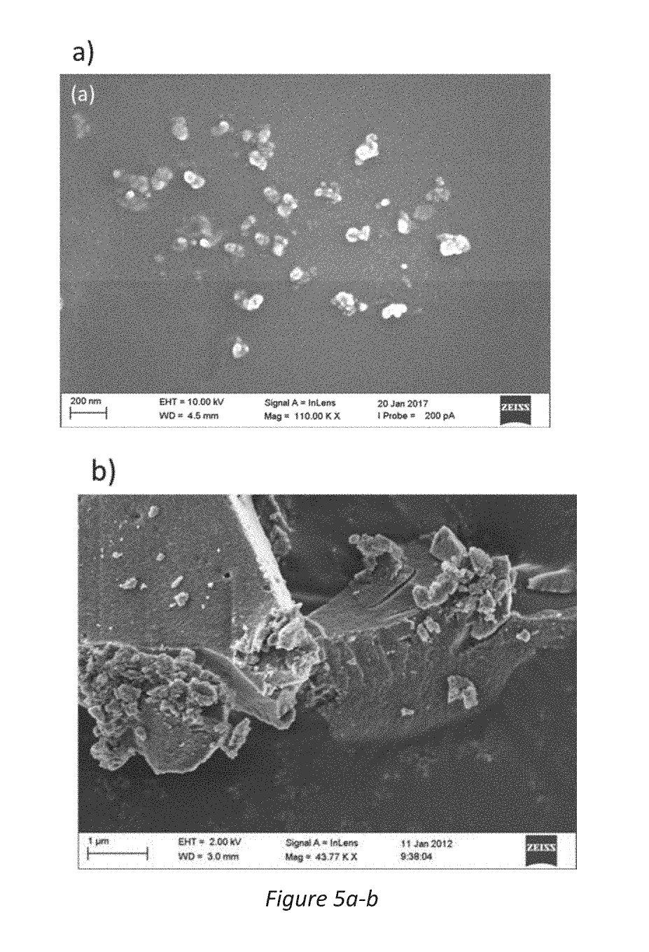

The intrinsic composite nanoparticles of the getter material according to the present invention is schematically illustrated in FIG. 4a and depicted in a SEM-image in FIG. 4b. The intrinsic composite nanoparticle 400 comprises of nanometre-sized crystalline MgO part 405 and layer of amorphous magnesium carbonate 410. An intrinsic composite nanoparticle may comprise a plurality of crystalline MgO parts 405 as in particle 411. The intrinsic composite nanoparticles may comprise a plurality of nanoparticles, which to some degree have clustered together 420. In the dried powder form the material has properties typically associated with materials comprising discrete nanoparticles, for example aerogels, such as a high total pore volume and high surface area compared to non-nanostructured materials. Samples of the getter material according to the invention have total pore volumes in the order of 1.5 cm³/g, determined with nitrogen sorption analysis. The porosity of the powder material are dominated by the interspace between individual particles as confirmed by SEM images, see FIGS. 4b and 5a-b. The getter material according to the present invention comprising intrinsic composite nanoparticles can be compared to materials formed with the method of forming continuous porous material of magnesium carbonate according to U.S. Pat. No. 9,580,330, as illustrated in the SEM image FIG. 5a-b, wherein (a) is the material according to the present invention comprising intrinsic composite nanoparticles and (b) is the material according to U.S. Pat. No. 9,580,330.

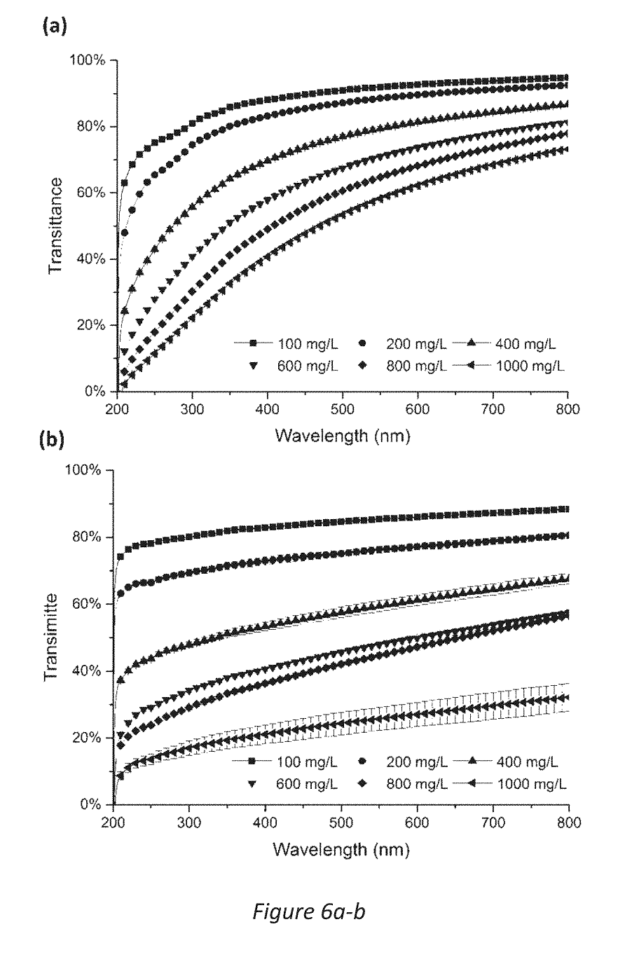

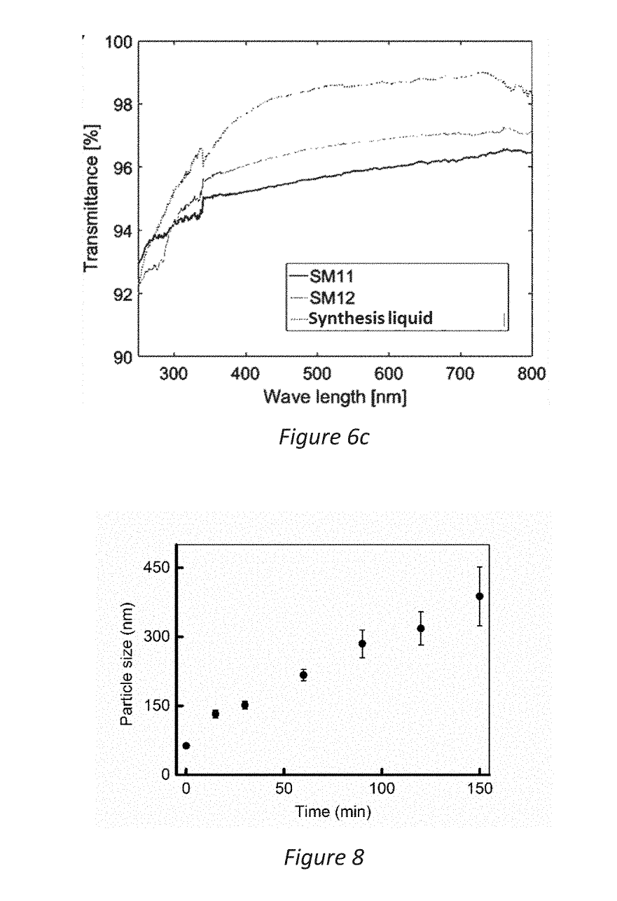

The composite nanoparticles of the getter material according to the present invention have a size range wherein 90% of the intrinsic composite nanoparticles or clusters of intrinsic composite nanoparticles have a size from 10 nm to 1 μm, preferably 10 nm to 200 nm, and even more preferably 10 nm to 50 nm. The size range is confirmed by analysis of SEM images and/or DLS analysis. The size range of the composite nanoparticles ensures that the getter material is suitable for transparent encapsulation in for example, but not limited to, OLED display, is suitable for thin film applications and that a suspension of composite nanoparticles is ink-jettable. The optical properties are illustrated in FIG. 6a-c, showing (6a-b) the transmittance as a function of wavelength for concentrations of 100 mg/L, 200 mg/L, 400 mg/L, 600 mg/L, 800 mg/L and 100 mg/L (top to bottom curves), wherein a) is a suspension comprising intrinsic composite nanoparticles according to the present invention and b) is a suspension of particles of the material according to U.S. Pat. No. 9,580,330, and c) are three samples of the getter material according to the invention prepared from respective reaction fluid (sol-gel suspension) diluted to 600 mg/l; In the visible region of 400-800 nm the transmittance for the suspension with intrinsic composite nanoparticles, T>60% at 600 mg/l, T>70% at 400 mg/l and T>80% at 200 mg/l. The corresponding transmittance for a suspension with material according to U.S. Pat. No. 9,580,330 is T<60% at 600 mg/l, T<70% at 400 mg/l and <80% at 200 mg/l. The samples of the getter material prepared directly from respective reaction fluid display transmittance T>90% for most of the wavelength region.

The intrinsic composite nanoparticles of the getter material according to the present invention has a composition of MgO and MgCO₃ ranging from 5 wt % MgO and 95 wt % MgCO₃ to 50 wt % MgO and 50 wt % of MgCO₃, as determined by Energy Dispersive X-ray Spectroscopy (EDS), unavoidably impurities and statistical fluctuations not included.

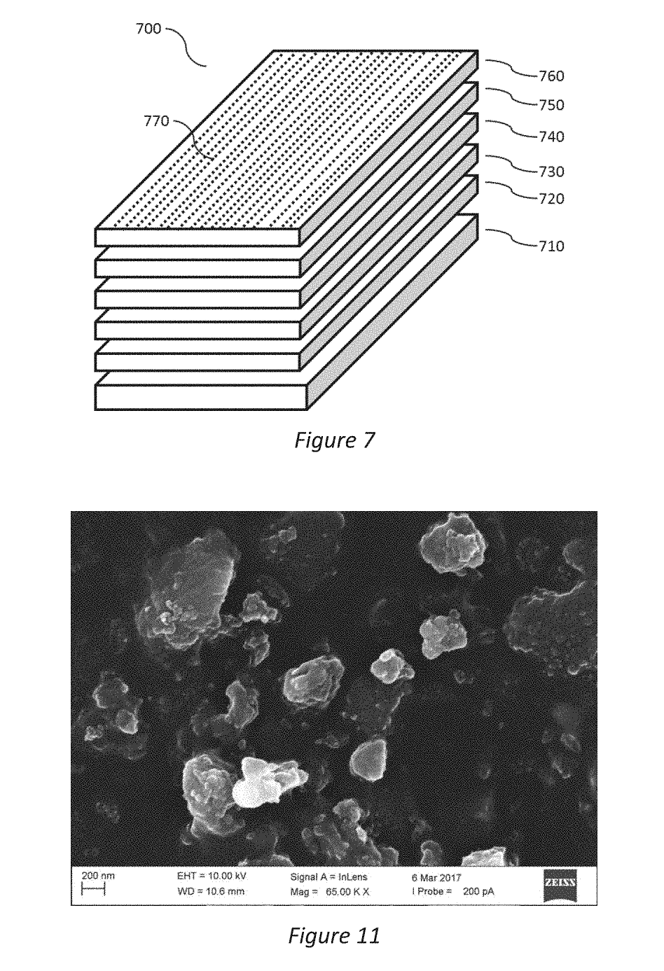

The combination of optical properties and adsorption properties makes the getter material according to the invention suitable to be provided in encapsulations and thin films of various kinds. An illustrative example is given with reference to FIG. 7 showing simplified OLED display 700, comprising a substrate 710, an anode 720, a conductive layer 730, an emissive layer 740, a cathode layer 750 and an encapsulation layer, or seal layer 760. The encapsulation layer is provided with the getter material 770 according to the invention. The size of the composite nanoparticles and their distribution in the encapsulation layer 760 ensures an essentially undisturbed viewing through the encapsulation layer 760. The encapsulation layer 760 is typically a plastic material, an ink-jettable organic smoothening layer or an adhesive. The getter material 770 may also be provided in other layers in the device, or in-between layers. The getter material 770 does not necessarily have to be provided evenly in the encapsulation layer 760, it could for example have higher concentrations towards the edges of the layer. Alternatively the getter material is provided as an edge encapsulation or in thin tapes provided only close to the edges of the layers in the device. Additional encapsulation layers for example inorganic layers deposited by CVD or ALD are envisaged also to be compatible with the getter material of this invention, and can be applied on layers with the getter of the invention underneath, above or in-between such inorganic encapsulation layers.

Flexible displays of different kind has drawn widespread interest. Flexible displays puts further demands on the getter material since the flexibility often is linked to even thinner layers and mechanical constrains and wear. The getter material according to the invention is particular advantageous in flexible applications.

As appreciated by the skilled person the described OLED is to be regarded as an illustrative example and the usage of the getter material according to the invention may be utilized in similar manners in a wide range of devices.

Another area wherein the getter material according to the invention is particularly advantageous is packaging, in particular food packaging. In these applications the getter material may be provided in a thin plastic foil used for wrapping a food item, for example.

The water adsorption process is partly different for magnesium oxide and the amorphous magnesium carbonate, which in certain application may be an advantage of the getter material of the invention. The magnesium carbonate typically adsorb water as crystal water (for example MgCO₃×3(H₂O)), whereas magnesium oxide typically reacts to magnesium hydroxide (Mg(OH)₂).

According to one embodiment of the invention the getter material is a mixed material comprising intrinsic composite nanoparticles and other getter materials, such as, but not limited to Zeolites, Calcium oxide. Active alumina, Barium Oxide, Magnesium oxide, Strontium oxide, Magnesium carbonate, Calcium carbonate and combinations thereof. One class of getter materials that are of interest are particles of metal oxides, preferably alkaline earth metal oxides, such as MgO and CaO. The additives are preferably in the form of nanoparticles, for example nano MgO, MgCO3 or CaO for the intrinsic composite nanoparticles to co-agglomerate with.

Of particular interest is a getter material comprising particles of MgO, since the process according to the invention offers a possibility to provide such a material without adding steps or complexity to the method. If step 310.4 of optionally separating superfluous MgO particles, is omitted, crystalline MgO particles will be present in the final product, the getter material. By choosing an appropriate separation method, for example altering centrifugal speed/time, the fraction of and/or the size of remaining MgO particles can be controlled. Alternatively, MgO particles or other additive such as CaO particles, are added at this stage, or later stages, of the process.

Also surfactants, doping materials, binders, stabilizers fillers etc. known to the skilled person can be present in the getter material.

In the chemical process described above producing the getter material according to the invention, like any other similar process, there will be a possibility of a few large particles (>1 μm) being formed. Such a few large particles can be separated by known separation techniques for example filtering or centrifuging. Thanks to the inventive method giving so few particles above the size range, such separation may be done without adversely affecting the yield.

### EXAMPLES AND EXPERIMENTS

An experimental study was made to investigate the formation process schematically outlined with reference to FIG. 1. Nanometer-sized aggregates of around 50-100 nm in diameter were detected in the sol-gel suspension after 24 hours of reaction, described above with references to the methods of FIGS. 2 and 3, using Dynamic Light Scattering (DLS), FIG. 8. Significant growth of these nanoparticles occurred with time when the reaction mixture was covered and left standing at room temperature (i.e. without active evaporation/drying). After 2 hours, the nanoparticles became too large to be detected by DLS. The observed particle growth most likely stems from aggregation of particles. CHN analysis, Inductively Coupled Plasma—Optical Emission Spectroscopy (ICP-OES), Thermogravimetric analysis (TGA), X-ray photoemission spectroscopy (XPS) and IR spectroscopy showed that these nanoparticles were composed of MgCO₃ and MgO. Since the highly porous magnesium carbonate is X-ray amorphous, it was concluded that the MgO that is comprised in the material was in the form of small (too small to be detected by powder XRD) nanometer-sized particles surrounded by amorphous MgCO₃. Hence, the amorphous magnesium carbonate can be seen as composite material.

A number of samples of the material according to the invention were produced with variations within the method according to the invention described with reference to the flowchart of FIG. 3. The samples are summarized in Table 1.

### Experimental Suite 1 (AMN-25, AMN-50, AMN-25C, AMN-50C, SM11)

The sol-gel suspension was dripped into a solvent at room temperature. The initial sol-gel suspension was formed using 1:15 of MgO:methanol (mass:volume) that reacted 2 days under 4 bar CO₂ pressure in room temperature under stirring. After the reaction suspension was formed, 5 mL of the obtained liquid was added dropwise in 250 ml stirring solvent, the solvent being methanol, ethanol. EtAc, or Petrolium ether. The resulting particle suspension was dried at 25° C. or 50° C. directly, or centrifuged to remove remaining MgO-particles and afterwards dried at 25° C. or 50° C. for 6 h to two weeks time. After that, the samples were heat-treated at 250° C. to remove organic remainders from the synthesis. The resulting sample are denoted AMN-25, AMN-50, AMN-25C, AMN-50C, in, where AMN-25 C and AMN-50C were centrifuged. Another sample synthesized by this method is denoted SM11. This sample was first dried for 2 h, removing a fraction of the suspension. A second fraction of the suspension was subtracted after 4 days of drying. The final powder was dried at 50° C. for 6 d and finally, at 70° C. for 24 h. After that, the powder was heat treated at 180° C. to remove solvent residues.

### Experimental Suite 2 (SM01, SM10, SM12, SM19, SM20)

In this example the sol-gel suspension was dripped into a solvent heated to its specific boiling point, the solvent being methanol, ethanol, EtAc. or Petrolium ether. The resulting nanoparticle suspensions obtained after a certain time of drying t at or slightly above room temperature, where 1 h<t<6 days.

### Experimental Suite 3 (SM19, SM20, S08-HT)

The fraction of metal oxide in the material can be altered by different methods:

In this example MgO or CaO nanoparticles were dispersed into the solvent under stirring. Then the sol-gel suspension was added dropwise to the solvent. Samples SM20 and SM19 are mixtures with MgO and CaO, respectively.

### Experimental Suite 4 (AMN50 in Polyethylene Plastic)

The getter material according to the invention can be blended into a plastic such as polyethylene, resulting in finely distributed intrinsic composite nanoparticles in the plastics. Composites of 0.1˜10 wt % nanoparticles in powder form and plastic has been prepared. In one example polyethylene plastic is heated to above its melting temperature and blended with nanoparticle powder to 5 wt % into the plastic melt.

Material Characterization

Material—Experimental Suite 1:

The nanoparticles of the getter material synthesized by dripping sol-gel suspension into a solvent at room temperature typically have size in the range from 20 nm to 200 nm, wherein the larger particles typically are clusters. The material is illustrated in the SEM-image of FIG. 4b. At least 90% of the intrinsic composite nanoparticles have a size <200 nm and at least 70% of the intrinsic composite nanoparticles have a size <50 nm, as determined from image analysis of the samples, see Table 2. The transmission properties previously discussed with reference to FIG. 6a was determined with a sample in this experimental suite, sample AMN-50. The total pore volume were determined using nitrogen adsorption analysis for two samples in this suite, sample AMN-50 and AMN-25, it was found to be 1.57 and 1.72 cm³/g, respectively.

Material—Experimental Suite 2:

The nanoparticles of the getter material synthesized by dripping the sol-gel suspension into solvent at the solvent boiling point typically have size in the range from 20 nm to 200 nm, wherein the larger particles typically are clusters (Table 2). The elemental composition evaluated from SEM-EDS for Materials in Experimental suite 2 are shown in Table 5. In Table 6, the phase composition from elemental analysis is displayed. The MgO content can be tuned from 5 to 20%. The optical properties are consistent with the result of the samples according to experimental suit 1.

Material—Experimental Suite 3:

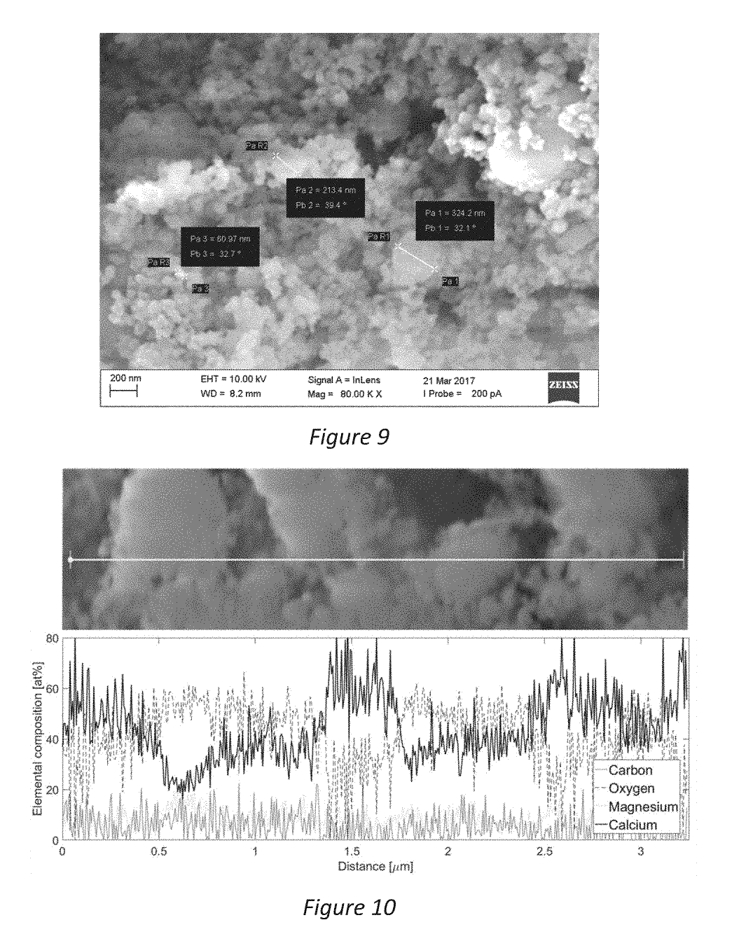

Materials with tuned MgO contents can be obtained by the methods described in Experimental suite 3. The MgO content can be tuned from 5 to 100%, preferably from 5 to 30% by the method described in Experimental suite 3. In FIG. 9, a SEM image of blended getter material being a mixture of intrinsic composite nanoparticles and CaO nanoparticles is displayed (sample SM19). The CaO particles are ˜60 nm in size, whereas the intrinsic composite nanoparticles in this sample are in the size range 200 nm-1 μm.

In FIG. 10, stacked SEM-EDS line scans of the getter material according to the invention, the mixed material sample SM19 are displayed. The wavelength of the compositional fluctuations of oxygen is ˜200-500 nm, corresponding to the intrinsic composite nanoparticle size. CaO nanoparticles reside at surfaces of the intrinsic composite nanoparticle or in the empty space between the nanoparticles.

Material Experimental Suite 4

FIG. 11 is a SEM images of separated intrinsic composite nanoparticle of sample AMN50 well dispersed in polyethylene were obtained by cutting a cross-section of the polyethylene-AMN50 composite.

TABLE 1
Notation and description of all material samples.

| | | Synthesis | | | | | |
|---|---|---|---|---|---|---|---|
| | | temperature | | | Drying | | Final drying |
| Name | Solvent | [° C.] | Drying time | | procedure | | temperature |
| AMN25 | EtAc | RT | 1 | week | 25° | C. | 250° C. |
| AMN50 | EtAc | RT | 3 | days | 50° | C. | 250° C. |
| AMN25C | EtAc | RT | 2 | days | 25° | C. | 250° C. |
| AMN50C | EtAc | RT | 6 | hours | 50° | C. | 250° C. |
| SM01 | PE (80-110) | 105 (BP PE) | 72 | h | 105° | C. | 180° C., VAC |
| S08 | PE(80-100) | 105 (BP PE) | 12 | h | 105° | C. | 180° C. |
| SM10 | EtAc | 70 (BP EtAc) | 48 h(12/1); | | 50° C. 6 d + | | 180° C. |
| | | | 6 d (16/1) | | 70° C. 6 h | | |
| SM11 | PE (80-100) | RT | 2 h(12/1); | | 50° C. 6 d + | | 180° C. |
| | | | 4 d(16/1) | | 70° C. 24 h | | |
| SM12 | PE (80-100) | 70 (BP MeOH) | 1 h(16/1); | | 50° C. 4 d + | | 180° C. |
| | | | 48 h(18/1) | | 20° C. 3 d | | |
| SM16 | Ethanol | 80 (BP EtOH) | 30 | min | RT 24 | h | 250 |
| SM17 | Methanol | 70 (BP MeOH) | 30 | min | RT 24 | h | 250 |
| SM19 | PE | 105 | 30 min, | | 80 C., 3 d | | 250 |
| | | | 60 min | | | | |
| SM20 | PE | 105 | 90 min, | | 105 C., 2 d + | | 250 |
| | | | 120 min | | 80 C., 1 h | | |
| SM16 | Ethanol | 80 (BP EtOH) | 30 | min | RT 24 | h | 250 |

TABLE 2
Calculated fractions of particles with size <200 nm and
<50 nm as obtained from image analysis of SEM image.

Fraction of particles [%]

| Name | <200 nm | <50 nm |
|---|---|---|
| AMN50 | 97 | 74 |

TABLE 3
Average elemental composition of the getter material comprising
intrinsic composite nanoparticle and crystalline CaO mixed
material, sampleSM19 evaluated from SEM-EDS.

| Element | Fraction [at %] | σ [%] |
|---|---|---|
| C | 9.3 | 1.9 |
| O | 52.3 | 4.6 |
| Mg | 9.0 | 2.3 |
| Ca | 29.4 | 5.2 |
| Total | 100.0 | |

TABLE 5
The average elemental composition measured
by SEM-EDS after drying at 250° C.

| Material | Elements | Fraction [at %] | σ [%] |
|---|---|---|---|
| SM01 | C | 18.3 | |
| SM01 | Mg | 23.7 | |
| SM01 | O | 57.9 | |
| SM12 | C | 24.8 | 0.3 |
| SM12 | Mg | 23.7 | 1.8 |
| SM12 | O | 49.9 | 1.3 |
| S08 | C | 16.6 | 4.3 |
| S08 | Mg | 28.8 | 5.0 |
| S08 | O | 54.6 | 2.3 |
| SM20 | C | 16.5 | |
| SM20 | Mg | 29.8 | |
| SM20 | O | 53.7 | |

1. A getter material suitable for incorporation in transparent layers, thin films or printed layers, the getter material characterized by intrinsic composite nanoparticles comprising one or more cores of crystalline magnesium oxide surrounded by amorphous magnesium carbonate, wherein 90% of the intrinsic composite nanoparticles is in a size range from 10 nm to 1 μm.

2. The getter material according to claim 1, wherein 90% of the intrinsic composite nanoparticles is in a size range from 10 nm to 200 nm, and preferably from 10 nm to 50 nm.

3. The getter material according to claim 1 or 2, wherein the composition ratio of magnesium oxide to magnesium carbonate of the getter material within the intrinsic composite particles, is in the range from 5:95 to 50:50, as determined by Energy Dispersive X-ray Spectroscopy.

4. The getter material according to any of claims 1 or 3, wherein the transmittance, T, for a suspension of the intrinsic composite nanoparticles in the visible region of 400-800 nm is, T>60% at a concentration of 600 mg/1, T>70% at 400 mg/l and T>80% at 200 mg/l.

5. The getter material according to any of claims 1 or 4, wherein the getter material further comprises a nano-sized particles of second type of getter material.

6. The getter material according to claim 5, wherein the getter material further comprises a metal oxide, preferably an alkaline earth metal oxide.

7. The getter material according to claim 6, wherein the second type of getter material is magnesium oxide and at least a portion of the magnesium oxide particles are residues from a process of producing the intrinsic composite nanoparticles of the getter material.

8. A liquid suspension comprising the getter material according to any of claims 1 to 7.

9. The suspension according to claim 8, wherein at least a portion of the suspension is a sol-gel suspension utilized in a process for producing the intrinsic composite nanoparticles of the getter material.

10. An intrinsic nanoparticle characterized by one or more cores of crystalline magnesium oxide, the one or more cores surrounded by a shell of amorphous magnesium carbonate forming a composite nanoparticle, and that the size of the composite nanoparticles is in a size range from 10 nm to 50 nm.

11. The intrinsic nanoparticle according to claim 10, wherein the composition ratio of magnesium oxide to magnesium carbonate within the intrinsic composite particle, is in the range from 5:95 to 50:50, as determined by Energy Dispersive X-ray Spectroscopy.

12. A method of producing a getter material suitable for incorporation in transparent layers, thin films or printed layers, the getter material comprising intrinsic composite nanoparticles comprising magnesium oxide and amorphous magnesium carbonate, and wherein crystalline magnesium oxide, MgO, is a starting material, the method comprising the main steps of:
sol-gel synthesis (310.1) comprising mixing magnesium oxide and methanol under CO2 pressure resulting in a sol-gel suspension;
formation of composite nanoparticles (310.2) in the sol-gel suspension, the nanoparticles formed with at least one core of crystalline magnesium oxide surrounded by amorphous magnesium carbonate;
halting formation and growth of nanoparticles (310.5) in the sol-gel suspension by mixing with a solvent.

13. The method according to claim 12, wherein the solvent is petroleum ether, ethanol, methanol or ethyl acetate or combinations thereof.

14. The method according to claim 12 or 13, further comprising a step of drying (330) the diluted sol-gel suspension to form a powder or aerogel of intrinsic composite nanoparticles.

15. The method according to claim 11 or 12, further comprising a step of adding nano-sized particles of second type of getter material.
